(19) United States
(12) Patent Application Publication
(10) Pub. No.: US 2016/0181000 A1
(43) Pub. Date: Jun. 23, 2016

(54) MAGNETIC ELEMENT USING BANK WINDING METHOD

(71) Applicant: DELTA ELECTRONICS, INC., Taoyuan Hsien (TW)

(72) Inventors: Cheng-Ching Yen, Taoyuan Hsien (TW); Tsai-Sheng Lin, Taoyuan Hsien (TW); Kun-Te Chen, Taoyuan Hsien (TW)

(21) Appl. No.: 14/821,230

(22) Filed: Aug. 7, 2015

(30) Foreign Application Priority Data
Dec. 23, 2014 (TW) 103144920

(51) Int. Cl. H01F 27/00; H01F 27/24

(52) U.S. Cl. CPC H01F 27/006; H01F 27/24

(57) ABSTRACT

A magnetic element using a bank winding method is provided. The magnetic element includes a toroid core module and at least two winding coil assemblies. The toroid core module includes a magnetic core, at least two first position-limiting structures and at least two second position-limiting structures. The at least two winding coil assemblies are wound around the toroid core module. The at least two winding coil assemblies are separated from each other through the at least two first position-limiting structures. Moreover, two adjacent windings of a middle portion of each winding coil assembly are separated by a specified length through the corresponding second position-limiting structure.

### FIELD OF THE INVENTION

The present invention relates to a magnetic element, and more particularly to a magnetic element using a bank winding method.

### BACKGROUND OF THE INVENTION

Nowadays, magnetic elements are widely applied to the circuitry of a communication system, a signal processing system, a filter and so on. Generally, the magnetic element comprises a winding coil assembly and a magnetic core. For increasing the impedance value, the winding coil assembly is usually wound around the magnetic core by a bank winding method. By the bank winding method, the winding coil assembly can be evenly wound around the magnetic core. Moreover, for complying with the bank winding standard, two adjacent windings of the middle portion of the winding coil assembly are separated by a specified length, so that the impedance value can be increased.

FIG. 1 schematically illustrates a conventional magnetic element using a bank winding method. As shown in FIG. 1, the conventional magnetic element 1 comprises a toroid core 10 and a winding coil assembly 11. The winding coil assembly 11 comprises a first coil 111 and a second coil 112. Since the toroid core 10 is ring-shaped, it is difficult to fix the winding coil assembly 11 on the toroid core 10. Moreover, since the bank winding method is manually controlled or managed by a jig tool, some drawbacks may occur. For example, if the user is careless or the jig tool is not precisely positioned, the space between two adjacent windings of the middle portion 10a of the first coil 111 or the second coil 112 of the winding coil assembly 11 cannot be maintained at the specified length or the winding coil assembly 1 cannot be evenly wound around the toroid core 10. Under this circumstance, the magnetic element 1 fails to comply with the bank winding standard, and the impedance value of the magnetic element 1 is low. Moreover, after the magnetic element 1 is applied to an electronic device, electromagnetic interference (EMI) is readily generated. Consequently, the performance of the electronic device is impaired.

Moreover, after the winding coil assembly 1 is wound around the toroid core 10, an insulation slice 12 is installed on an inner surface of the toroid core 10 in order to isolate and separate the first coil 111 from the second coil 112. However, the procedure of installing insulation slice 12 is labor-intensive and time-consuming. Consequently, the fabricating cost of the magnetic element is increased and the fabricating process is complicated.

Therefore, there is a need of providing an improved magnetic element so as to overcome the above drawbacks.

### SUMMARY OF THE INVENTION

An object of the present invention provides a magnetic element having a mechanism for assisting in fixing and positioning the winding coil assemblies in order to enhance the performance and reduce the fabricating cost.

In accordance with an aspect of the present invention, there is provided a magnetic element using a bank winding method. The magnetic element includes a toroid core module and at least two winding coil assemblies. The toroid core module includes a magnetic core, at least two first position-limiting structures and at least two second position-limiting structures. The at least two winding coil assemblies are wound around the toroid core module. The at least two winding coil assemblies are separated from each other through the at least two first position-limiting structures. Moreover, two adjacent windings of a middle portion of each winding coil assembly are separated by a specified length through the corresponding second position-limiting structure.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional magnetic element using a bank winding method;

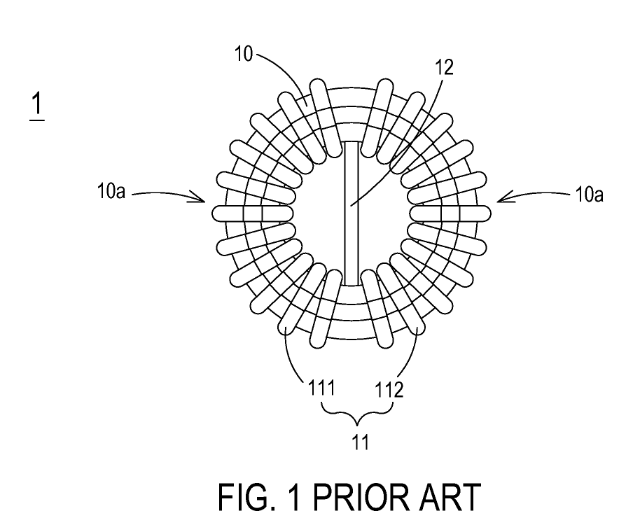

FIG. 2A is a schematic exploded view illustrating a magnetic element using a bank winding method according to a first embodiment of the present invention;

FIG. 2B is a schematic assembled view of the magnetic element of FIG. 2A;

FIGS. 3A and 3B schematically illustrate two variant examples of the magnetic element of FIG. 2B; and

FIG. 4 is a schematic exploded view illustrating a magnetic element using a bank winding method according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

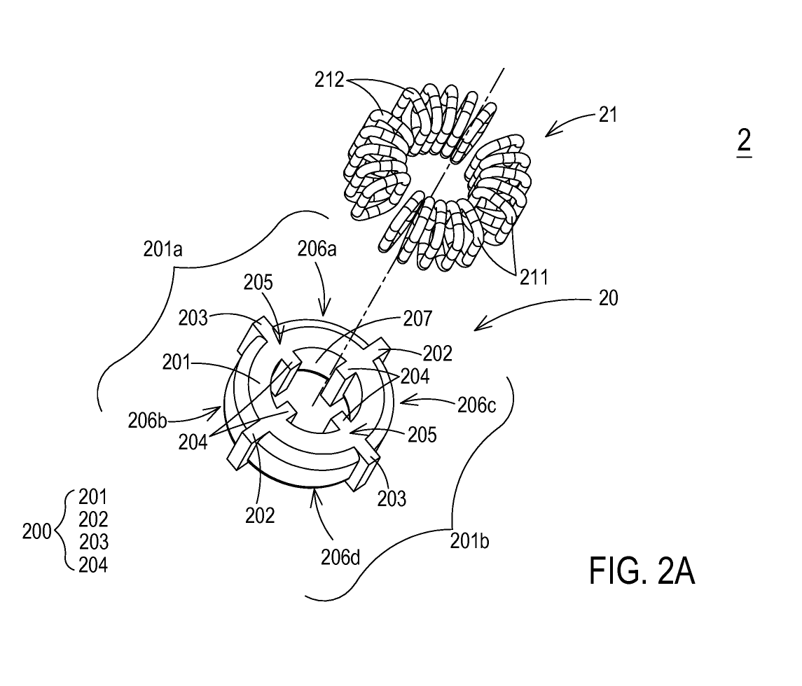

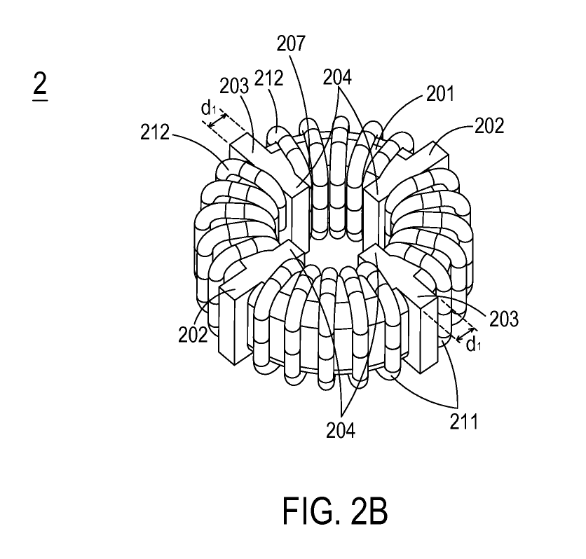

FIG. 2A is a schematic exploded view illustrating a magnetic element using a bank winding method according to a first embodiment of the present invention. FIG. 2B is a schematic assembled view of the magnetic element of FIG. 2A. The magnetic element 2 comprises a toroid core module 20 and at least two winding coil assemblies 21. An example of the magnetic element 2 includes but is not limited to an inductor or a filter. The toroid core module 20 comprises a magnetic core 200, at least two first position-limiting structures 202 and at least two second position-limiting structures 203. In this embodiments, the at least two winding coil assemblies 21 comprise two coils, which are wound around the toroid core module 20 by a bank winding method. The at least two winding coil assemblies 21 are separated from each other through the at least two first position-limiting structures 202. Through the at least two first position-limiting structures 202, the at least two winding coil assemblies 21 are separated from each other. Through the second position-limiting structure 203, the two adjacent windings of the middle portion of the corresponding winding coil assembly 21 (i.e. the windings of the winding coil assembly 21 corresponding to a middle region 205 of a ring-shaped body 201 of the magnetic core 200) are separated by a specified length d1. Due to the specified length d1, the at least two winding coil assemblies 21 can comply with the bank winding standard.

The magnetic core 200 of the toroid core module 20 further comprises the ring-shaped body 201. In this embodiment, the toroid core module 20 comprises two first position-limiting structures 202. The two first position-limiting structures 202 are symmetrical to each other, and protruded externally from an outer surface of the ring-shaped body 201. Through the two first position-limiting structures 202, the ring-shaped body 201 of the magnetic core 200 is divided into a first zone 201a and a second zone 201b. Moreover, each of the first zone 201a and a second zone 201b has a middle region 205. In this embodiment, the at least two winding coil assemblies 21 comprise a first winding coil 211 and a second winding coil 212. The first winding coil 211 and the second winding coil 212 are wound around the ring-shaped body 201 of the magnetic core 200 by the bank winding method. In particular, the first winding coil 211 is wound around the first zone 201a, the second winding coil 212 is wound around the second zone 201b, and the first winding coil 211 and the second winding coil 212 are separated from each other through the two first position-limiting structures 202.

In this embodiment, the toroid core module 20 comprises two second position-limiting structures 203. The two second position-limiting structures 203 are symmetrically protruded from the outer surface of the ring-shaped body 201 corresponding to the middle regions 205. Through the two second position-limiting structures 203, the first zone 201a is divided into a first sub-zone 206a and a second sub-zone 206b, and the second zone 201b is divided into a third sub-zone 206c and a fourth sub-zone 206d. The circumferences of the sub-zones 206a, 206b, 206c and 206d are equal. Moreover, the second position-limiting structure 203 corresponding to the middle region 205 of each of the first zone 201a and the second zone 201b has the specified length d1. Due to the specified length d1, the first winding coil 211 can be evenly wound around the first sub-zone 206a and the second sub-zone 206b, and the second winding coil 212 can be evenly wound around the third sub-zone 206c and the fourth sub-zone 206d. That is, due to the specified length d1 of the second position-limiting structure 203, the first winding coil 211 and the second winding coil 212 can be wound around the ring-shaped body 201 of the magnetic core 200 more easily while complying with the bank winding standard. Consequently, the magnetic element 2 has the low impedance.

In a preferred embodiment, the at least two first position-limiting structures 202 and at least two second position-limiting structures 203 are integrally formed with the ring-shaped body 201 of the magnetic core 200. Under this circumstance, the materials of the ring-shaped body 201, the at least two first position-limiting structures 202 and at least two second position-limiting structures 203 are identical to the magnetic material of the magnetic core 200.

Please refer to FIG. 2A again. The magnetic core 200 further comprises at least two partition structures 204. In this embodiment, the magnetic core 200 comprises four partition structures 204. The four partition structures 204 are symmetrical to each other. Two of the four partition structures 204 are aligned with the two first position-limiting structures 202, and the other two partition structures 204 are aligned with the two second position-limiting structures 203. Moreover, the four partition structures 204 are protruded from an inner surface 207 of the ring-shaped body 201. Through the four partition structures 204, the parts of the first winding coil 211 and the second winding coil 212 inside the ring-shaped body 201 are isolated from each other. In a preferred embodiment, the two first position-limiting structures 202, the second position-limiting structures 203 and the four partition structures 204 are integrally formed with the ring-shaped body 201 of the magnetic core 200. Under this circumstance, the materials of the ring-shaped body 201, the two first position-limiting structures 202, the second position-limiting structures 203 and the four partition structures 204 are identical to the magnetic material of the magnetic core 200. It is noted that the number, type and arrangement of the partition structures 204 may be varied according to the practical requirements.

As mentioned above, since the at least two first position-limiting structures 202, at least two second position-limiting structures 203 and the at least two partition structures 204 are installed on the magnetic core 200 of the toroid core module 20, the magnetic core 200 of the toroid core module 20 can be used as a winding jig. Moreover, due to the configurations of the toroid core module 20, the at least two winding coil assemblies 21 are fixed on the magnetic core 200 and not moved relative to the magnetic core 200. That is, the configurations of the toroid core module 20 can assist in the winding process and facilitate mass production. Moreover, through the at least two first position-limiting structures 202, the first winding coil 211 and the second winding coil 212 are not contacted or overlapped with each other during the winding process. Moreover, through the at least two first position-limiting structures 202, the first winding coil 211 and the second winding coil 212 on the magnetic core 200 are not very close to each other. Consequently, the impedance value is not reduced. Moreover, through the at least second position-limiting structures 203, the two adjacent windings of the middle portion of the first winding coil 211 (or the second winding coil 212) corresponding to the middle region 205 are separated by the specified length d1. Since the uncertain factor of the human's judgment can be eliminated, the at least two winding coil assemblies 21 can comply with the bank winding standard more easily. Under this circumstance, the impedance value is satisfied and the performance of the magnetic element is enhanced. Moreover, the arrangement of the at least two partition structures 204 can replace the insulation slice 12 of the conventional magnetic element. Through the at least two partition structures 204, the parts of the first winding coil 211 and the second winding coil 212 inside the ring-shaped body 201 are isolated from each other. Moreover, since the at least two partition structures 204 are integrally formed with the ring-shaped body 201, the procedure of installing the insulation slice 12 during the winding process will be omitted. Under this circumstance, the winding process is simplified, and the throughput is increased.

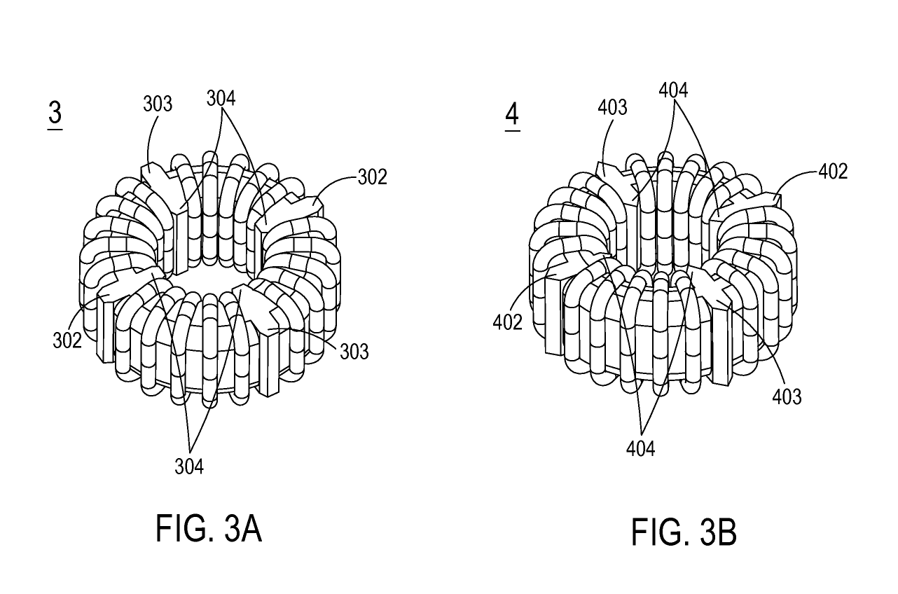

In the above embodiment, the first position-limiting structures 202, the second position-limiting structures 203 and the partition structures 204 are rectangular protrusion blocks. The first position-limiting structures 202 and the second position-limiting structures 203 are protruded from the outer surface of the ring-shaped body 201, and the partition structures 204 are protruded from the inner surface 207 of the ring-shaped body 201. It is noted that numerous modifications and alterations may be made while retaining the teachings of the invention. FIGS. 3A and 3B schematically illustrate two variant examples of the magnetic element of FIG. 2B. As shown in FIG. 3A, the first position-limiting structures 302, the second position-limiting structures 303 and the partition structures 304 of the magnetic element 3 are trapezoid protrusion blocks. As shown in FIG. 3B, the first position-limiting structures 402, the second position-limiting structures 403 and the partition structures 404 of the magnetic element 4 are triangular protrusion blocks. In other words, the profiles of the first position-limiting structures, the second position-limiting structures and the partition structures of the magnetic element may be varied according to the practical requirements.

Moreover, the numbers of the first position-limiting structures, the second position-limiting structures and the partition structures of the magnetic element may be varied according to the practical requirements. For example, in some other embodiments, the magnetic element comprises three first position-limiting structures, three second position-limiting structures and three partition structures, and further comprises three winding coil assemblies 21. Each winding coil 21 is arranged between two adjacent first position-limiting structures. Through the second position-limiting structure, the two adjacent windings of the middle portion of the corresponding winding coil assembly 21 are separated by the specified length d1. Since the two adjacent windings of the middle portion of the corresponding winding coil assembly 21 are separated from each other through the second position-limiting structure, the winding coil assembly 21 can comply with the bank winding standard. Moreover, through the partition structures, the parts of the winding coil assemblies 21 inside the ring-shaped body 201 are isolated from each other. In other words, the numbers, types and arrangements of the first position-limiting structures, the second position-limiting structures and the partition structures of the magnetic element of the present invention are not restricted.

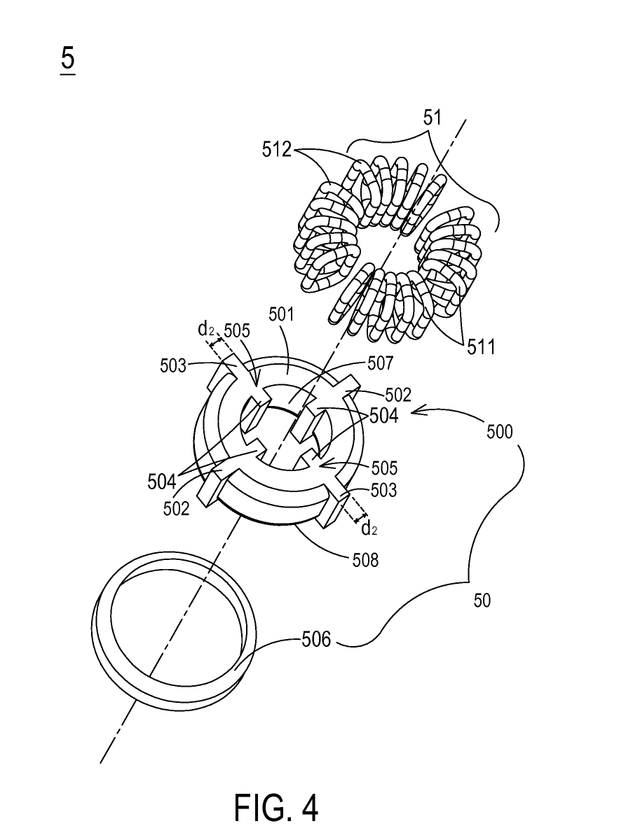

FIG. 4 is a schematic exploded view illustrating a magnetic element using a bank winding method according to a second embodiment of the present invention. The magnetic element 5 comprises a toroid core module 50 and at least two winding coil assemblies 51. The toroid core module 50 comprises an insulating cover 500 and a magnetic core 506. The magnetic core 506 is a toroid core. The insulating cover 500 is sheathed around the magnetic core 506. The insulating cover 500 comprises an insulating body 501, at least two first position-limiting structures 502, at least two second position-limiting structures 503 and at least two partition structures 504. The numbers, types and arrangements of the first position-limiting structures 502, the second position-limiting structures 503 and the partition structures 504 are similar to those of the first embodiment, and are not redundantly described herein. Especially, in this embodiment, the first position-limiting structures 502, the second position-limiting structures 503 and the partition structures 504 are disposed on the insulating body 501 rather than the magnetic core 506.

The insulating cover 500 is made of an insulating material. The first position-limiting structures 502 and the second position-limiting structures 503 are protruded from an outer surface of the insulating body 501. The partition structures 504 are protruded from an inner surface 507 of the insulating body 501. Moreover, a ring-shaped recess 508 is formed in a bottom surface of the insulating body 501. The profile of the ring-shaped recess 508 matches the profile of the magnetic core 506. Consequently, the magnetic core 506 can be accommodated within the ring-shaped recess 508 of the insulating cover 500. Then, the first winding coil 511 and the second winding coil 512 of the two winding coil assemblies 51 are wound around the insulating body 501 of the insulating cover 500 by the bank winding method. The first winding coil 511 and the second winding coil 512 are separated from each other through the first position-limiting structures 502. Through the second position-limiting structure 503, the adjacent windings of the middle portion of the first winding coil 511 (or the second winding coil 512) corresponding to the middle region 505 of the insulating body 501 are separated by a specified length d2. Due to the specified length d2, the first winding coil 511 and the second winding coil 512 can comply with the bank winding standard.

From the above descriptions, the present invention provides a magnetic element. The magnetic element comprises a toroid core module and at least two winding coil assemblies. The toroid core module comprises a magnetic core and optionally an insulating cover. Moreover, at least two first position-limiting structures and at least two second position-limiting structures are formed on the magnetic core or the insulating cover for assisting in fixing and positioning the at least two winding coil assemblies. Consequently, the winding coil assemblies can be evenly wound around the magnetic core by a bank winding method. Moreover, through the at least two second position-limiting structures, the at least two winding coil assemblies can comply with the bank winding standard. Since the winding coils are not overlapped, the impedance value is increased and the performance of the magnetic element is enhanced. Moreover, through the at least two partition structures, the procedure of installing the insulation slice during the winding process will be omitted. Consequently, the winding process is simplified, the fabricating cost is reduced, and the throughput is increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic element using a bank winding method, the magnetic element comprising:
a toroid core module comprising a magnetic core, at least two first position-limiting structures and at least two second position-limiting structures; and
at least two winding coil assemblies wound around the toroid core module,
wherein the at least two winding coil assemblies are separated from each other through the at least two first position-limiting structures, and two adjacent windings of a middle portion of each winding coil assembly are separated by a specified length through the corresponding second position-limiting structure.

2. The magnetic element according to claim 1, wherein the magnetic core has a ring-shaped body, wherein the at least two first position-limiting structures are symmetrically protruded from an outer surface of the ring-shaped body, wherein the at least two second position-limiting structures are symmetrically protruded from the outer surface of the ring-shaped body.

3. The magnetic element according to claim 2, wherein the ring-shaped body is divided into a first zone and a second zone through the at least two first position-limiting structures, and the at least two second position-limiting structures are located at the first zone and the second zone, respectively.

4. The magnetic element according to claim 3, wherein the magnetic core further comprises at least two partition structures, wherein the at least two partition structures are symmetrically protruded from an inner surface of the ring-shaped body, and aligned with the corresponding first position-limiting structures and/or the corresponding second position-limiting structures.

5. The magnetic element according to claim 4, wherein the at least two first position-limiting structures, at least two second position-limiting structures and the at least two partition structures are integrally formed with the ring-shaped body of the magnetic core.

6. The magnetic element according to claim 1, wherein the toroid core module further comprises an insulating cover, wherein the insulating cover is sheathed around the magnetic core, and the at least two first position-limiting structures and at least two second position-limiting structures are disposed on the insulating cover.

7. The magnetic element according to claim 6, wherein the insulating cover comprises an insulating body, wherein the insulating body is divided into a first zone and a second zone through the at least two first position-limiting structures, and the at least two second position-limiting structures are located at the first zone and the second zone, respectively.

8. The magnetic element according to claim 7, wherein the insulating cover further comprises at least two partition structures, wherein the at least two partition structures are symmetrically protruded from an inner surface of the insulating body, and aligned with the corresponding first position-limiting structures and/or the corresponding second position-limiting structures.

9. The magnetic element according to claim 8, wherein the at least two first position-limiting structures, at least two second position-limiting structures and the at least two partition structures are integrally formed with the insulating body of the insulating cover.
